(19) United States
(12) Patent Application Publication
(10) Pub. No.: US 2007/0054088 A1
(43) Pub. Date: Mar. 8, 2007

(54) UV-Cured Hot-Melt Adhesive

(75) Inventors: Christelle Matijasic, Knutwil (CH); Pia Frei, Rickenbach (CH); Andreas Dobmann, Oberkirch (CH)

Correspondence Address: SHOEMAKER AND MATTARE, LTD, 10 POST OFFICE ROAD - SUITE 110, SILVER SPRING, MD, 20910, US

(73) Assignee: Collano AG, Sempach-Station (CH)

(21) Appl. No.: 10/547,765

(22) PCT Filed: Mar. 1, 2004
(86) PCT No.: PCT/EP04/02033

§ 371 Date: Apr. 28, 2006

(30) Foreign Application Priority Data
Mar. 19, 2003 (EP) 03405189.6

(51) Int. Cl. B32B 3/04

(52) U.S. Cl. 428/123

(57) ABSTRACT

The inventive composition contains at least one polyacrylate that can be melted and cross-linked using UV light, optional additives and is characterised by an oligomer compound comprising at least one functional group that can be cross-linked using UV, said compound having a viscosity of between 0.1 and 20 Pa·s at 25° C. The invention also relates to the use of the composition as a UV cross-linked hot-melt adhesive and to a method for producing a substrate that is provided with the composition. The composition can be used at a lower temperature than previous conventional hot-melt adhesives.

The invention relates to a UV-curable composition, to the use of this UV-curable composition as a hotmelt adhesive, and to a coating method with the composition for application with temperature-sensitive support materials.

Hotmelt adhesives are increasingly gaining in importance for a variety of adhesive applications in industry. Crosslinkable hotmelt adhesives have the advantage here that these materials can first be applied as a melted film to a support and can be modified by crosslinking reaction to give high molecular weight compounds. This crosslinking reaction can be initiated thermally or by means of radiation, especially radiation in the UV light range. As a result of the meltability of these adhesives it is possible largely to forgo the use of solvents, with the known disadvantages.

These crosslinkable hotmelt adhesives are based usually on addition polymers having corresponding, reactive groups. Addition polymers crosslinkable with UV light are known for example from DE-A 3 844 444, DE-A 10 103 428, WO-A 01/23488, WO-A 01/23489 or WO-A 01/84544 and the documents cited in said publications.

Generally speaking, these crosslinkable hotmelt adhesives are processed—that is, applied to a substrate—at temperatures between 120 and 160° C. It has been found, however, that this procedure is not suitable for all substrate materials and application methods. A variety of materials such as PE, PP or PVC lose their stability at such high temperatures and undergo deformation or are even partly destroyed. For certain application methods, such as screen printing, there is an upper, tolerable viscosity limit. Here as well, an increase in application temperature in order to lower the melt viscosity can lead to destruction of the substrate. Attempts to lower the processing temperature and application temperature by addition of an additive lead to the disadvantage known as fogging, i.e, the emission of these additives from the exposed hotmelt adhesive composition. Vaporous emission of the additives in this way, however, cannot be tolerated in a variety of applications, e.g., in the automobile or aircraft industries.

It is the object of the present invention to avoid the disadvantages of the known art and to provide in particular a UV-crosslinkable hotmelt adhesive which can be processed at lower temperatures without serious limitations on its properties.

This object is achieved by means of a composition comprising a UV-crosslinkable polyacrylate, by the use of said composition, and by a coating method which can be performed therewith, in accordance with the independent claims.

The composition of the invention comprises a meltable polyacrylate, crosslinkable with UV light and optionally additives and is characterized by at least one oligomeric compound having UV-crosslinkable functional groups which are reactive with the polyacrylate.

The oligomeric compound therefore contains preferably at least one UV-crosslinkable functional group. With a further advantage, the amount of the oligomeric compound is selected such that essentially at least one functional group per oligomeric compound reacts with the polyacrylate.

With a further advantage the oligomeric compound possesses a lower viscosity than the polyacrylate, and so the oligomeric compound acts as a kind of diluent.

In one preferred embodiment the oligomeric compound has a viscosity of between 0.1 and 20 Pa·s at 25° C. (Brookfield measurement system). The polyacrylate advantageously has a viscosity of 1 to 100 Pa·s at 130° C. (cone/plate measurement system, EN ISO 3219).

The polyacrylate crosslinkable or curable with UV light is a free-radically polymerized addition polymer which is composed, to the extent of at least 50% by weight of the polymer, of C₂ to C₁₈ alkyl (meth)acrylates, with 0.1% to 30% by weight of the monomers of which the polymer is synthesized being monomers A without carboxylic acid or carboxylic anhydride groups and with a water solubility of greater than 5 g of monomer per liter of water. The addition polymer is obtained from ethylenically unsaturated, free-radically polymerizable compounds. This polymer is composed to an extent of preferably 50% to 99.85%, more preferably 60% to 99.4%, and very preferably 80% to 98.9% by weight, based on the polymer, of C₂ to C₁₈ alkyl (meth)acrylates. Preference is given to C₂ to C₁₀ alkyl (meth)acrylates, e.g. n-butyl acrylate, ethyl acrylate, and 2-ethylhexyl acrylates. In particular, mixtures of the alkyl (meth)acrylates are used.

In order to improve the crosslinking the addition polymer may comprise a UV light sensitive photoinitiator. The photoinitiator may be attached to the polymer, or else may be unattached and merely mixed with the polymer. Customary photoinitiators which can be added to the polymer are, for example, acetophenone, benzoin ethers, benzyl dialkyl ketols or derivatives thereof. The amount of admixed photoinitiator is preferably 0.05 to 10 parts by weight, and more preferably 0.1 to 2 parts by weight per 100 parts by weight of addition polymer.

As a result of irradiation with high-energy light, especially UV light in the wavelength range between 200 to 450 nm, the photoinitiator brings about accelerated onset of the crosslinking of the polymer, preferably by means of a chemical grafting reaction of the photo-initiator with a spatially adjacent polymer chain. Crosslinking may take place, for example, by the insertion of a carbonyl group of the photoinitiator into an adjacent C—H bond to form a —C—C—O—H moiety. In principle the polyacrylate contains functional groups which by virtue of their structure exhibit a propensity to react when irradiated with light in the UV range. These are, for example, C—C, C—O, and C—N multiple bonds. Also conceivable is the conjugated presence of these double or triple bonds.

In the case of a copolymerized photoinitiator the addition polymer contains 0.05% to 10%, preferably 0.1% to 2%, and more preferably 0.1% to 1% by weight (based on the polymer) of ethylenically unsaturated compounds having a photoinitiator group. The ethylenically unsaturated compound contains at least one acrylic or methacrylic group. Suitable photoinitiator components are acetophenone or benzophenone derivatives. The photoinitiator group is preferably separated by a spacer group from the ethylenically unsaturated group of the compound. This spacer group may contain, for example, up to 100 carbon atoms. The spacer group reduces the likelihood of an intramolecular cross-linking reaction and advances intermolecular cross-linking.

Suitable acetophenone or benzophenone derivatives are described for example in EP-A 346 734, EP-A 377 199 (1st claim), DE-A 4 037 079 (1st claim) and DE-A 3 844 444 (1st claim) and are hereby adopted into the disclosure content of this specification. The preferred acetophenone and benzophenone derivatives are those of the formula 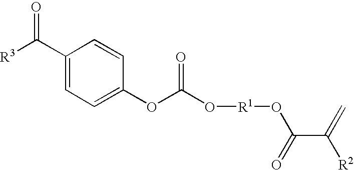
in which R¹ is an organic radical having up to 30 carbon atoms, R2 is a hydrogen atom or a methyl group, and R³ is an unsubstituted or substituted phenyl group or a C₁-C₄ alkyl group.

R¹ is more preferably an alkylene group, in particular a C₂ to C₈ alkylene group.

R³ is more preferably a methyl group or a phenyl group. Further monomers from which the polyacrylate may be synthesized are, for example, vinyl esters of carboxylic acids containing up to 20 carbon atoms, vinylaromatics having up to 20 carbon atoms, ethylenically unsaturated nitriles, vinyl halides, vinyl ethers of alcohols having 1 to 10 carbon atoms, aliphatic hydrocarbons having 2 to 8 carbon atoms and 1 or 2 double bonds, or mixtures of these monomers.

Suitable vinyl aromatic compounds include, for example, vinyltoluene, α- and β-methylstyrene, α-butylstyrene, 4-n-butylstyrene, 4-n-decylstyrene, and, preferably, styrene. Examples of nitriles are acrylonitrile and methacrylonitrile.

The vinyl halides are ethylenically unsaturated compounds substituted by chlorine, fluorine or bromine, preferably vinyl chloride and vinylidene chloride. Vinyl ethers include, for example, vinyl methyl ether or vinyl isobutyl ether. Preference is given to vinyl ethers of alcohols containing 1 to 4 carbon atoms.

As hydrocarbons having 2 to 8 carbon atoms and two olefinic double bonds mention may be made of butadiene, isoprene and chloroprene.

Suitable further monomers include in particular monomers containing carboxylic acid, sulfonic acid or phosphoric acid groups, carboxylic acid groups being preferred. Examples are acrylic acid, methacrylic acid, itaconic acid, maleic acid or fumaric acid. Further monomers are, for example, monomers containing hydroxyl groups, especially C₁ to C₁₀ hydroxyalkyl (meth)-acrylates or (meth)acrylamide. Mention is made further of phenyloxyethyl glycol mono(meth)acrylate, glycidyl acrylate, glycidyl methacrylate, and amino (meth)-acrylates such as 2-aminoethyl (meth)acrylates.

Monomers which in addition to the double bond also carry further functional groups, e.g., isocyanate, amino, hydroxyl, amide or glycidyl groups, may, for example, improve the adhesion of the addition polymer.

The polyacrylate preferably has a K value of 30 to 80 and more preferably of 40 to 60, measured in tetra-hydrofuran (1% strength solution, 21° C.). The K value according to Fikentscher is a measure of the molecular weight and viscosity of the polymer. The glass transition temperature (T_{g}) of the addition polymer is preferably −60 to +10° C., more preferably −55 to 0° C., and very preferably −55 to −10° C. The glass transition temperature of the polyacrylate can be determined by customary methods such as differential thermal analysis or differential scanning calorimetry (see, e.g., ASTM 3418/82, “midpoint temperature”).

The polyacrylates can be prepared by copolymerizing the monomeric components, using the customary polymerization initiators and, if desired, regulators, polymerization taking place at the customary temperatures in bulk (without solvent), in emulsion, e.g., in water or liquid hydrocarbons, or in solution. The copolymers are preferably prepared by polymerizing the monomers in solvents, in particular in solvents with a boiling range of 50 to 150° C., preferably of 60 to 120° C., using the customary amount of polymerization initiators, which in general is 0.01% to 10%, in particular 0.1% to 4% by weight (based on the total weight of the monomers). Suitable solvents include in particular alcohols, such as methanol, ethanol, n- and isopropanol, n- and isobutanol, preferably isopropanol and/or isobutanol, and also hydrocarbons such as toluene and, in particular, petroleum spirits having a boiling range of 60 to 120° C. It is also possible to use ketones, such as acetone, methyl ethyl ketone, and methyl isobutyl ketone, and esters, such as ethyl acetate, and also mixtures of solvents of the type stated. Mixtures containing isopropanol and/or isobutanol in amounts of 5% to 95%, in particular of 10% to 80%, preferably of 25% to 60% by weight, based on the solvent mixture employed, are preferred.

Suitable polymerization initiators in the case of solution polymerization include, for example, azo compounds, ketone peroxides, and alkyl peroxides.

After the polymerization in solution the solvents can be separated off if desired under reduced pressure. This operation is conducted at elevated temperatures, in the range of 100 to 150° C. for example. The addition polymers can be employed thereafter in the solvent-free state, i.e., as a melt. It is sometimes advantageous to prepare the UV-crosslinkable addition polymers by polymerization in bulk, i.e., without use of a solvent. The polymerization of the components employed can in this case take place batchwise or continuously, as described for example in DE-A 2 439 341.

The composition of the invention may comprise further additives, such as stabilizers or optical brighteners, for example.

The oligomeric compounds containing at least one UV-crosslinkable functional group bring about the advantageous lowering of the processing temperature of this composition. For the purposes of the present invention an oligomeric compound is a molecule which contains at least 2 to 15 repeating monomer units in the structure. Further, reference is made to the definition in Römpp, Lexikon Lacke und Druckfarben, Georg Thieme Verlag Stuttgart, New York, 1998, “oligomers”, page 425. The at least one UV-crosslinkable functional group of the oligomeric compound is selected such that a reaction takes place with the functional groups of the addition polymer and/or of the photoinitiator groups preferably incorporated in the addition polymer by copolymerization. Advantageously these UV-crosslinkable groups are arranged substantially terminally on the oligomeric compound. As a result of these reactions, therefore, the molecule is attached chemically permanently to the addition polymer. Any subsequent emission—for example, outgassing from the crosslinked composition—is, accordingly, prevented. The oligomeric compound preferably has at least two functional groups. Particular preference is given to an oligomeric compound having four functional groups. Suitable functional groups of this kind are, for example, a vinyl group or a carbonyl group. Also conceivable is the conjugated presence of two or more of these groups.

The amount of the oligomeric compound is to be chosen such that at least one of the UV-crosslinkable functional groups of the oligomeric compound enters into a chemically permanent bond, i.e., substantially a covalent bond, with the polyacrylate within the exposure phase of the composition and/or the cooling phase of the melted composition. As a result of the quantitative selection it is possible to prevent evaporation of the oligomeric compound from the exposed and crosslinked composition.

The oligomeric compound advantageously possesses a viscosity of between 0.1 and 20 Pa·s at 25° C. Such a viscosity range has a beneficial effect on the capacity for the composition of the invention to be processed at significantly lower temperatures. The compound preferably has a viscosity of between 2 and 17 Pa·s and more preferably of between 4 and 15 Pa·s at 25° C. (Brookfield measurement system).

The oligomeric compound preferably has a molecular weight of less than 2500 g/mol, more preferably less than 1800 g/mol, and with further preference of less than 1400 g/mol.

The oligomeric compound is advantageously a urethane acrylate, epoxy acrylate, polyester acrylate or mixtures thereof. The oligomeric compound preferably possesses at least two functional groups and with further advantage at least four functional groups. The plurality of the functional groups ensures sufficient reactivity of the oligomeric compound in respect of crosslinking. A particularly preferred oligomeric compound is a urethane acrylate, in particular a urethane acrylate having two functional groups. Further preference is given to a urethane acrylate having four functional groups. The urethane functionality also proves advantageous for the adhesive properties of the crosslinked composition. Through an appropriate selection of the urethane acrylate it is therefore possible to exert influence additionally on the adhesive properties.

Of further advantage is a composition of the invention in which the polyacrylate comprises 70% to 98% by weight and the oligomeric compound 2% to 30% by weight of the total composition. Preferably the composition contains 75% to 95% by weight of polyacrylate and 5% to 25% by weight of oligomeric compound.

The composition of the invention can be used as a crosslinkable hotmelt adhesive. For that purpose the composition is heated to a processing temperature of between 60 and 160° C., preferably between 70 and 140° C., and more preferably between 80 and 120° C., and is applied to a substrate. The substrate used can be a foil or film, a paper, a polymeric substrate, or a textile. The foil or film, or the polymeric substrate, may be composed of PET, PE, PP, polyamide or PU. With great advantage the composition of the invention can be applied to temperature-sensitive materials, since these materials are not destroyed at the application temperature. The crosslinkable layer is applied with a thickness of between 1 and 200 μm, preferably between 10 and 140 μm, and more preferably between 15 and 80 μm. Subsequent exposure to UV light, preferably in a wavelength range between 200 and 300 nm, initiates the crosslinking reaction of the composition. The light source used may be, for example, a UV laser or an Hg lamp. The applied composition is customarily exposed with a UV dose (in a wavelength range from 200 to 300 nm) of 0.01 to 10 J/cm². The skilled worker is aware of suitable UV light sources.

The coating is crosslinked advantageously much quicker than a polyacrylate composition which has no inventive addition of the oligomeric compound, so that higher application speeds and/or processing speeds of the coated substrate are possible.

Despite the significantly lower processing temperature, the crosslinked compositions achieve identical properties. With the inventive composition it is possible to obtain shearing temperatures (SAFT, shear adhesion failure temperature, measured along the lines of ASTM D4498-00, 25 mm×25 mm, 1000 g, 0.5° C./min, 24 h adhesive bonding) of around 150° C.

The examples below illustrate the composition of the invention. The percentages are in each case by weight and are based on the total weight of the composition.

acResin® from BASF is used as a polyacrylate component in the composition. This class of substance is distinguished by copolymerized monomers attached chemically to which, using a spacer group, are UV-activable photoinitiator groups. Through different proportions of the monomers used it is possible to custom-tailor the properties of the polymer.

### EXAMPLE 1

Intimately admixed with 84.7% of acResin A 203 UV are 15% of Actilane 276 (Akcros Chemical America, tetra-functional urethane acrylate with M_{w} of 1000 g/mol) and also 0.3% of Irganox B 612 (Ciba SC). The composition is of high viscosity at room temperature. For application, the mixture is heated at 100 to 110° C. and applied using a hotmelt adhesive coating apparatus from Nordson to a PET film (Wachendorf, 50 μm thick). Crosslinking is initiated by exposure with a UV minicure exposure apparatus (from IST) at a transport speed of 10 m/min and a lamp output of 160 W/cm. The output of the UV light source used is 0.8 J/cm² (in a wavelength range from 200 to 300 nm).

With a bonded test strip, an SAFT temperature of greater than 150° C. was found.

### EXAMPLE 2

A mixture of 89.7% of acResin A 203 UV, 10% of Actilane 276 and 0.3% of Irganox B 612 is prepared in the same way as in Example 1 and applied at a temperature of 100-120° C. to a PET substrate. An SAFT temperature of greater than 140° C. was determined.

Following exposure and after crosslinking, the example compositions were investigated for their fogging behavior. Fogging, as outlined above, is the deleterious outgassing of monomers or small molecules, which in certain applications must not occur. The samples (surface area approximately 200 cm²) were heated in a glass cylinder, using an oil bath, at 100° C. for 16 hours. The lid of the cylinder was at the same time actively cooled at 21° C. Differential weighing of the lid before and after the temperature treatment gave the fraction of volatile constituents in the crosslinked composition (in accordance with DIN 75210 B).

In this test the samples investigated showed no loss of mass—in other words, no loss of mass outside the error range of the method.

1-13. (canceled)

14. A composition comprising a meltable, UV-crosslinkable polyacrylate, wherein the composition comprises an oligomeric compound having UV-crosslinkable functional groups which are reactive with the polyacrylate.

15. The composition of claim 14, wherein the viscosity of the oligomeric compound is lower than the viscosity of the polyacrylate.

16. The composition of claim 14, wherein the oligomeric compound has a viscosity of between 0.1 and 20 Pa·s at 25° C.

17. The composition of claim 14, wherein the polyacrylate has a viscosity of between 1 and 100 Pa·s at 130° C.

18. The composition of claim 14, wherein the polyacrylate is composed of an addition polymer with 0.05% to 10% by weight of ethylenically unsaturated compounds having a photoinitiator group.

19. The composition of claim 14, wherein the oligomeric compound is a urethane acrylate.

20. The composition of claim 19, wherein the oligomeric compound is a urethane acrylate having two crosslinkable functional groups.

21. The composition of claim 19, wherein the oligomeric compound is a urethane acrylate having four crosslinkable functional groups.

22. The composition of claim 14, wherein the polyacrylate comprises 70% to 95% by weight and the oligomeric compound 5% to 30% by weight of the total composition.

23. The composition of claim 14, wherein the composition comprises a UV initiator.

24. The composition of claim 14, wherein the urethane acrylate has a molecular weight of less than 2500 g/mol.

25. The composition of claim 24, wherein the urethane acrylate has a molecular weight of less than 1800 g/mol.

26. The composition of claim 14, wherein the amount of the oligomeric compound is selected such that essentially at least one functional group per oligomeric compound can react with the polyacrylate.

27. A method of coating a substrate with an adhesive layer, comprising the steps of:
providing a composition of claim 14;
melting the composition and applying the melt to a substrate; and
exposing the applied composition to ultraviolet radiation to crosslink the components present in the composition.

28. The method of claim 24, wherein the melting takes place in the temperature range between 70 and 140° C.

29. The method of claim 24, wherein the composition is applied with a layer thickness of between 1 and 200 μm.

30. The method of claim 24, wherein the composition is applied with a layer thickness of between 10 and 140 μm, to the substrate.
